(19) United States
(12) Patent Application Publication
(10) Pub. No.: US 2023/0305237 A1
(43) Pub. Date: Sep. 28, 2023

(54) FERRULE, OPTICAL CONNECTOR AND OPTICAL CONNECTOR MODULE

(71) Applicant: Enplas Corporation, Saitama (JP)

(72) Inventor: Ayano HINATA, Saitama (JP)

(73) Assignee: Enplas Corporation, Saitama (JP)

(21) Appl. No.: 18/114,256

(22) Filed: Feb. 26, 2023

(30) Foreign Application Priority Data
Feb. 28, 2022 (JP) 2022-029902

(51) Int. Cl. G02B 6/38

(52) U.S. Cl. CPC G02B 6/3834; G02B 6/3861

(57) ABSTRACT

A ferrule includes an optical transmission member holding member configured to hold an optical transmission member; and a ferrule main body to which the optical transmission member holding member is inserted. The ferrule main body includes an insertion part to which the optical transmission member holding member is inserted, a first optical surface disposed to face an end surface of the optical transmission member held by the optical transmission member holding member, and a positioning part configured to set a position of the optical transmission member holding member when the optical transmission member holding member is inserted to the insertion part.

### CROSS REFERENCE TO RELATED APPLICATIONS

This application claims the benefit of priority of Japanese Patent Application No. 2022-029902, filed on Feb. 28, 2022, the contents of which are incorporated by reference as if fully set forth herein in their entirety.

### TECHNICAL FIELD

The present invention relates to a ferrule, an optical connector and an optical connector module.

### BACKGROUND ART

A ferrule is known to place an optical transmission member (such as an optical fiber and an optical waveguide) is disposed, and receive light from the optical transmission member. The ferrule is configured such that the end portion of the optical transmission member can be disposed at an appropriate position.

For example, PTL 1 discloses an optical repeater disposed between a substrate and an optical connector (ferrule). The optical connector (ferrule) includes a main body part, two positioning pins and a plurality of optical fiber holes.

### CITATION LIST

### Patent Literature

### PTL 1

Japanese Patent Application Laid-Open No. 2016-180946

### SUMMARY OF INVENTION

### Technical Problem

To use a single-mode optical fiber in the known ferrule as disclosed in PTL 1, it is necessary to more correctly set the position of the end surface of the optical fiber. In addition, there is a risk of breaking of the optical fiber when inserting the optical fiber to the optical fiber hole.

An object of the present invention is to provide a ferrule with which the optical transmission member can be easily aligned and the optical transmission member is less broken. In addition, another object of the present invention is to provide an optical connector and an optical connector module including the above-described ferrule.

### Solution to Problem

A ferrule of an embodiment of the present invention includes: an optical transmission member holding member configured to hold an optical transmission member; and a ferrule main body to which the optical transmission member holding member is inserted. The ferrule main body includes: an insertion part to which the optical transmission member holding member is inserted, a first optical surface disposed to face an end surface of the optical transmission member held by the optical transmission member holding member, and a positioning part configured to set a position of the optical transmission member holding member when the optical transmission member holding member is inserted to the insertion part.

An optical connector of an embodiment of the present invention includes: the above-described ferrule; and an optical transmission member held by the optical transmission member holding member.

An optical connector module of an embodiment of the present invention includes the above-described optical connector.

### Advantageous Effects of Invention

According to the present invention, it is possible to provide a ferrule with which the optical transmission member can be easily aligned and the optical transmission member is less broken. In addition, according to the present invention, it is possible to provide an optical connector and an optical connector module including the above-described ferrule.

### BRIEF DESCRIPTION OF DRAWINGS

FIG. 1A is a see-through perspective view of an optical connector according to Embodiment 1, and FIG. 1B is a sectional view of the optical connector according to Embodiment 1;

FIG. 2A is a plan view of a main body of a ferrule according to Embodiment 1, and FIG. 2B is a bottom view;

FIG. 3A is a front view of the main body of the ferrule according to Embodiment 1, FIG. 3B is a rear view, and FIG. 3C is a left side view, and FIG. 3D is a right side view;

FIGS. 4A and 4B are sectional views of the main body of the ferrule according to Embodiment 1;

FIG. 5A is a perspective view of an optical transmission member holding member according to Embodiment 1, FIG. 5B is a plan view, FIG. 5C is a front view, FIG. 5D and is a right side view;

FIG. 6A is a see-through perspective view of an optical connector according to Embodiment 2, and FIG. 6B is a sectional view;

FIG. 7A is a back view of a ferrule main body according to Embodiment 2, and FIG. 7B is a sectional view;

FIG. 8A is a perspective view of an optical transmission member holding member according to Embodiment 2, FIG. 8B is a plan view, FIG. 8C is a front view, and FIG. 8D is a right side view;

FIG. 9A is a see-through perspective view of an optical connector according to Embodiment 3, and FIG. 9B is a sectional view; and

FIGS. 10A and 10B are back views of a ferrule according to Embodiment 3.

### DESCRIPTION OF EMBODIMENTS

### Embodiment 1

### Configuration of Optical Connector

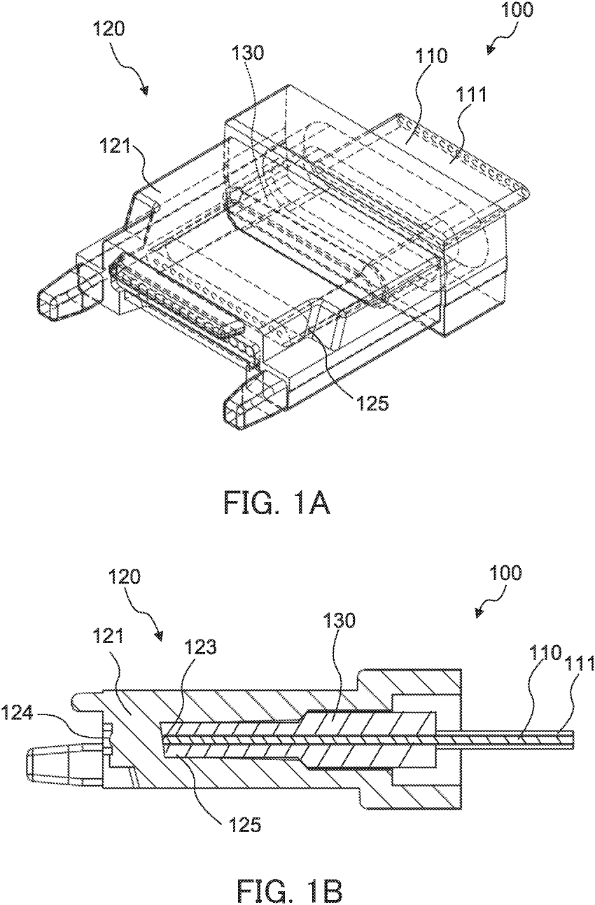

FIG. 1A is a see-through perspective view illustrating a configuration of optical connector 100 according to Embodiment 1 of the present invention, and FIG. 1B is a sectional view.

As illustrated in FIGS. 1A and 1B, optical connector 100 according to the present embodiment includes optical transmission member 110 and ferrule 120. Ferrule 120 includes ferrule main body 121, and optical transmission member holding member 130. Optical transmission member holding member 130 holds optical transmission member 110. In the state of holding optical transmission member 110, optical transmission member holding member 130 is inserted to ferrule main body 121. When optical transmission member holding member 130 is inserted to ferrule main body 121, the position of optical transmission member holding member 130 is set by positioning part 125 of ferrule main body 121, and the position of the end portion of optical transmission member 110 is aligned with respect to first optical surface 123 of ferrule main body 121. In this manner, in the present invention, when optical transmission member holding member 130 is inserted to ferrule main body 121, optical transmission member 110 can be aligned by positioning part 125. Optical connector 100 according to the present embodiment can be used as an optical connector module with a housing, a spring clamp structure part and the like.

The number of optical transmission members 110 is not limited, and one or a plurality of optical transmission members 110 may be provided. In the present embodiment, a plurality of optical transmission members 110 is provided. The plurality of optical transmission members 110 is bundled by cover part 111 in a row in a form of a ribbon.

The type of optical transmission member 110 is not limited. Examples of the type of optical transmission member 110 include optical fibers and optical waveguides. In the present embodiment, optical transmission member 110 is an optical fiber. In addition, the optical fiber may be of a single mode type or a multiple mode type.

### Configuration of Ferrule

As described above, ferrule 120 includes ferrule main body 121, and optical transmission member holding member 130. Ferrule 120 is used in the state where optical transmission member holding member 130 holding optical transmission member 110 is inserted to ferrule main body 121. In addition, in the present embodiment, a combination of two ferrules 120 with the same shape may be used. More specifically, by fitting the irregularities of the front surfaces of two ferrules 120 to each other with the top surface of one ferrule 120 facing up and the bottom surface of the other ferrule 120 facing up, the optical transmission members held by respective ferrules 120 can be optically coupled with each other. A configuration of ferrule main body 121 and a configuration of optical transmission member holding member 130 are described below in turn.

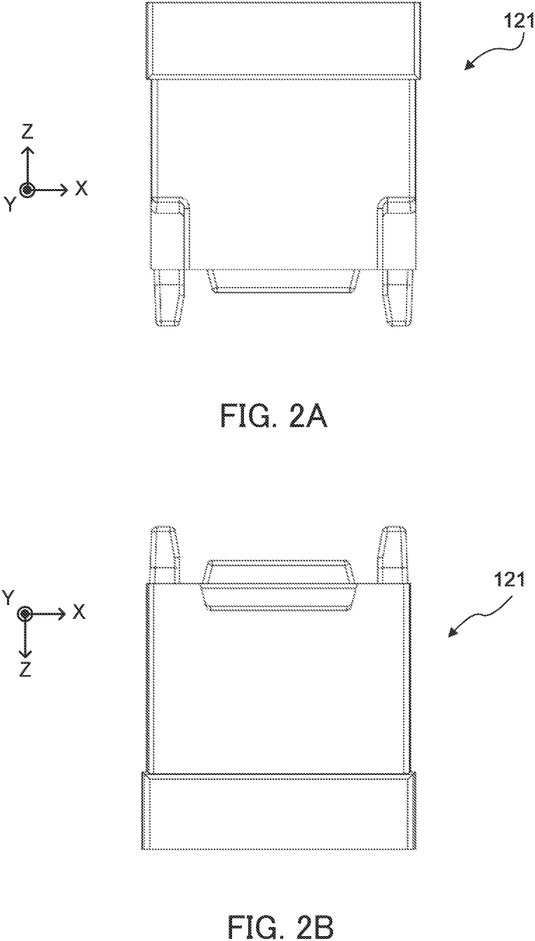

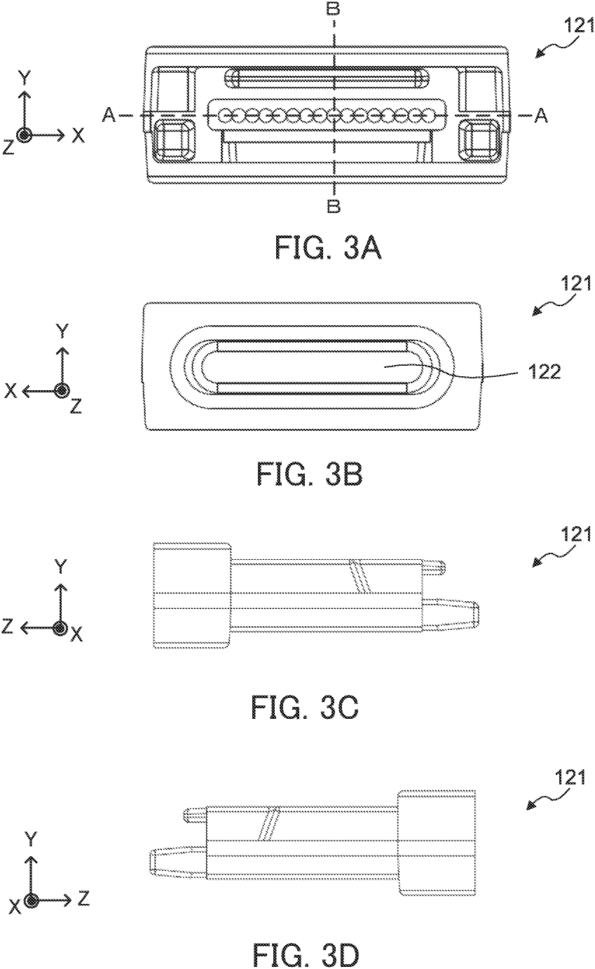

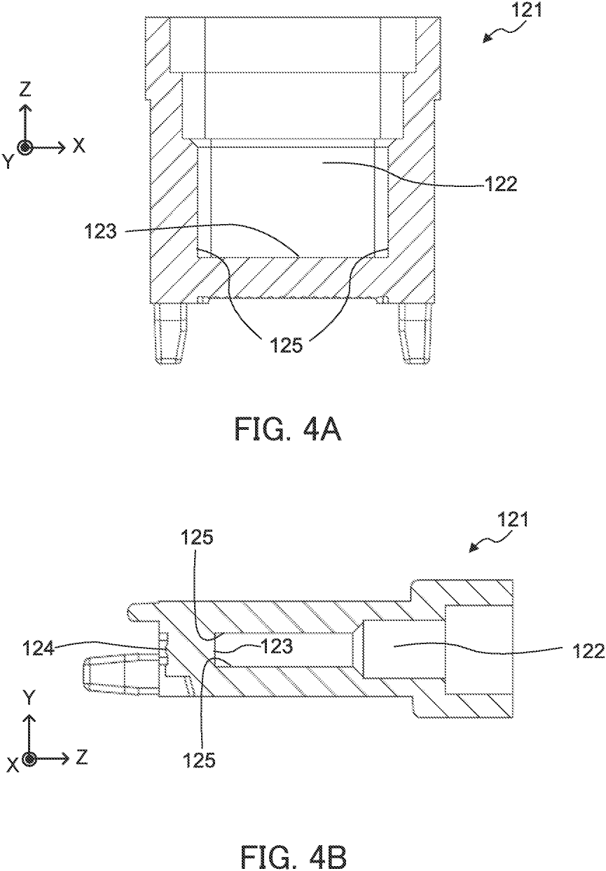

FIG. 2A is a plan view of ferrule main body 121 according to Embodiment 1 of the present invention, and FIG. 2B is a bottom view. FIG. 3A is a front view of ferrule main body 121 according to Embodiment 1 of the present invention, FIG. 3B is a rear view, and FIG. 3C is a left side view, and FIG. 3D is a right side view. FIGS. 4A and 4B are sectional views of ferrule main body 121 according to Embodiment 1 of the present invention. FIG. 4A is a sectional view taken along line A-A of FIG. 3A, and FIG. 4B is a sectional view taken along line B-B of FIG. 3A.

Note that in the following description, the direction along the bottom surface of ferrule main body 121 in front view and back view of ferrule main body 121 as illustrated in FIG. 3A is “X direction”. In addition, the direction orthogonal to the X direction is “Y direction”. The “Y direction” is the direction (height direction) along the side surface in front view and back view of ferrule main body 121. In addition, “Z direction” is the direction orthogonal to “X direction” and “Y direction”. The “Z direction” is the direction along the bottom surface of ferrule main body 121 in side view of ferrule main body 121. In the present embodiment, the plurality of optical transmission members 110 is arranged in the X direction, and extended in the Z direction.

As illustrated in FIGS. 2A to 4B, ferrule main body 121 is a member with a substantially cuboid shape. Ferrule main body 121 includes insertion part 122, first optical surface 123, and positioning part 125.

Insertion part 122 is a portion where optical transmission member holding member 130 is inserted. Insertion part 122 is a recess that opens at the back surface of ferrule main body 121. The shape of insertion part 122 may be set as necessary in accordance with the shape of optical transmission member holding member 130. In the present embodiment, the shape of optical transmission member holding member 130 is a substantially plate shape (substantially cuboid shape), and insertion part 122 also has a substantially cuboid shape. In addition, as is clear from FIG. 3B, the opening of insertion part 122 has a substantially rectangular shape extending in the X direction and the Y direction.

As illustrated in FIGS. 4A and 4B, first optical surface 123 is a surface facing the end surface of optical transmission member 110 held by optical transmission member holding member 130. First optical surface 123 is a surface that allows incidence of light from the end surface of optical transmission member 110, or emits, toward the end surface of optical transmission member 110, light entered from second optical surface 124 disposed at a position facing first optical surface 123. First optical surface 123 may be a flat surface or a curved surface. In addition, first optical surface 123 may be a tilted surface tilted with respect to the insertion direction (the Z direction) of optical transmission member holding member 130 into insertion part 122. Such a tilted first optical surface 123 can reduce a situation where light from optical transmission member 110 is reflected at first optical surface 123 and returned to optical transmission member 110. Note that in the present invention, the position in the insertion direction (the Z direction) of the end surface of optical transmission member 110 may not be set by the contact of optical transmission member 110 with first optical surface 123. The reason for this is that in the present invention, the position of optical transmission member 110 in the Z direction can be set by optical transmission member holding member 130 that holds optical transmission member 110, and ferrule main body 121.

Second optical surface 124 is a surface disposed to face first optical surface 123. Second optical surface 124 is a surface that emits, to the outside of ferrule main body 121, the light from light transmission body 110 entered from first optical surface 123. In addition, second optical surface 124 is a surface that allows the light from the outside of ferrule main body 121 to enter the ferrule main body. Second optical surface 124 may be a flat surface or a curved surface. In the present embodiment, second optical surface 124 is a curved surface, or more specifically, a convex lens.

Positioning part 125 is a part that sets the position by making contact with optical transmission member holding member 130 when optical transmission member holding member 130 is inserted to insertion part 122. In the present embodiment, optical transmission member holding member 130 is press-fitted to ferrule main body 121 at positioning part 125. More specifically, in the present embodiment, positioning part 125 is a tapered surface tapering in the direction from the opening of insertion part 122 toward first optical surface 123 at the inner surface of insertion part 122 (see FIGS. 4A and 4B). With the positioning part disposed at the tapered surface, when gradually inserting optical transmission member holding member 130 to insertion part 122, the clearance therebetween gradually decreases, and finally optical transmission member holding member 130 and positioning part 125 make contact with each other, thus setting the position of optical transmission member holding member 130 (see FIGS. 1A and 1B). The range, position (the range and position of positioning part 125) and the like of the contact may be set as necessary. Although the inclination angle is small and unclear in FIGS. 4A and 4B, in the present embodiment, the tapered surface functioning as positioning part 125 is disposed at least near the deepest part of insertion part 122.

Preferably, in a cross-sectional view along the XZ plane as illustrated in FIG. 4A, positioning part 125 is disposed in a manner opposing in the X direction at the inner surface of insertion part 122 In this manner, the position of optical transmission member holding member 130 in the X direction can be easily set.

In addition, preferably, in a cross-sectional view along the YZ plane as illustrated in FIG. 4B, positioning part 125 is disposed in a manner opposing in the Y direction at the inner surface of insertion part 12. In this manner, the position of optical transmission member holding member 130 in the Y direction can be easily set.

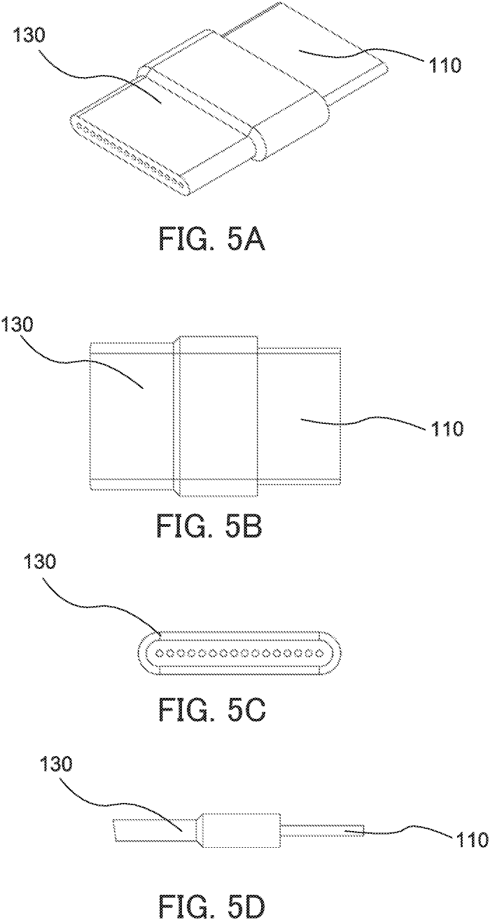

FIG. 5A is a perspective view of optical transmission member holding member 130, FIG. 5B is a plan view, FIG. 5C is a front view, and FIG. 5D is a right side view. FIGS. 5A to 5D illustrate a state where optical transmission member holding member 130 holds optical transmission member 110. In the present embodiment, optical transmission member holding member 130 includes a plurality of through holes, and holds optical transmission member 110 with optical transmission member 110 inserted to the through holes.

As illustrated in FIGS. 5A and 5B, optical transmission member holding member 130 has a substantially plate shape (substantially cuboid shape). The shape of optical transmission member holding member 130 is not limited as long as it is configured to be positioned at an appropriate position with positioning part 125 when inserted to insertion part 122 of ferrule main body 121. More specifically, the shape of optical transmission member holding member 130 need only have a portion makes contact with positioning part 125.

In optical transmission member holding member 130, the surface of optical transmission member holding member 130 that makes contact with positioning part 125 may be or may not be a tapered surface. More specifically, in plan view of optical transmission member holding member 130, the left and right side surfaces may be parallel to each other, or may be tapered from the opening of insertion part 122 toward first optical surface 123. In addition, in side view of optical transmission member holding member 130, upper and lower side surfaces may be parallel to each other, or may be tapered from the opening of insertion part 122 toward first optical surface 123.

### Effects

With ferrule 120 according to the present embodiment, since optical transmission member 110 is inserted to ferrule main body 121 in the state of being held by optical transmission member holding member 130, it is less broken when positioning the end surface of optical transmission member 110 with respect to first optical surface 123. In addition, with the tapered surface serving as positioning part 125, optical transmission member holding member 130 that holds optical transmission member 110 is easily disposed at an appropriate position. In this manner, the position of the end surface of optical transmission member 110 is easily set with respect to first optical surface 123.

### Embodiment 2

### Configuration of Optical Connector and Ferrule

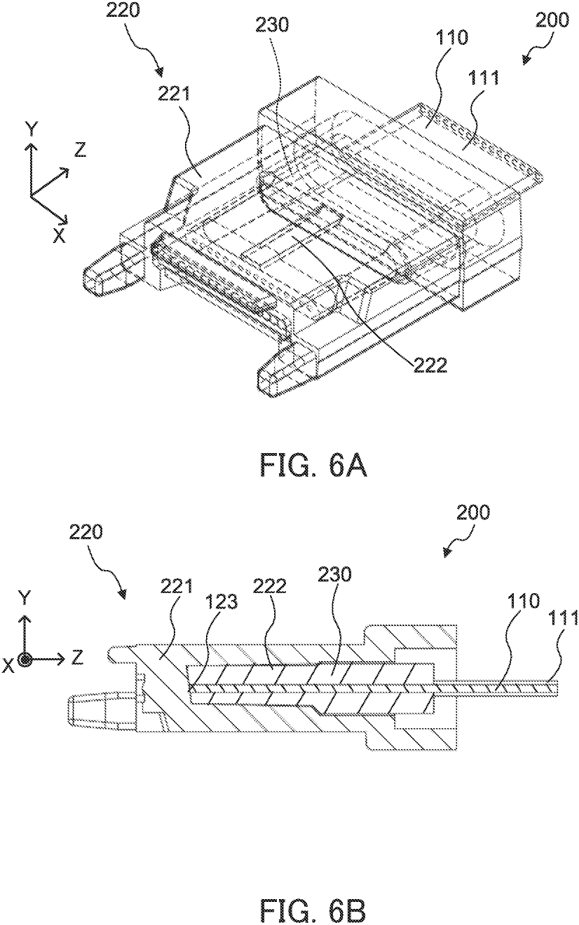

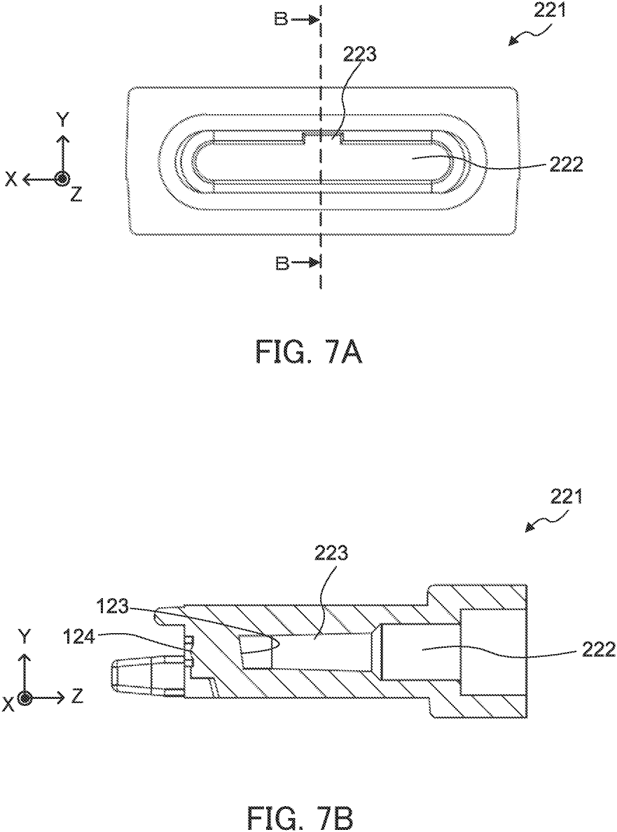

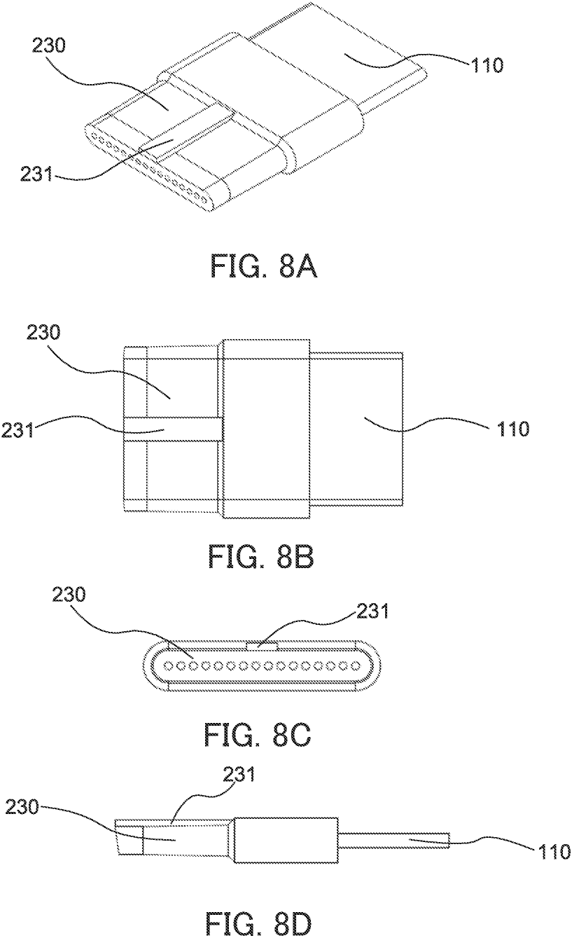

FIG. 6A is a see-through perspective view illustrating a configuration of optical connector 200 according to Embodiment 2 of the present invention, and FIG. 6B is a sectional view. FIG. 7A is a back view of ferrule main body 221 according to Embodiment 2, and FIG. 7B is a sectional view taken along line B-B of FIG. 7A. FIG. 8A is a perspective view of optical transmission member holding member 230 that is inserted to ferrule main body 221 according to Embodiment 2, FIG. 8B is a plan view, FIG. 8C is a front view, and FIG. 8D is a right side view. In Embodiment 2, the same members as those of Embodiment 1 are denoted with the same reference numerals, and the description thereof is omitted.

As illustrated in FIGS. 7A and 7B, ferrule main body 221 is different from ferrule main body 121 according to Embodiment 1 in that valley 223 extending in the insertion direction (the Z direction) into insertion part 222 is provided as a positioning part. In addition, optical transmission member holding member 230 includes ridge 231 for setting the position of optical transmission member holding member 230 together with the above-described valley 223. Ridge 231 extends in the insertion direction (the Z direction) into insertion part 222. In the present embodiment, the position of optical transmission member holding member 230 is set by fitting valley 223 and ridge 231 to each other.

While ferrule main body 221 includes valley 223 and optical transmission member holding member 230 includes ridge 231 in the above-described example, ferrule main body 221 and optical transmission member holding member 230 may include a ridge and a valley, respectively.

### Effects

With ferrule 220 according to Embodiment 2, since optical transmission member 110 is inserted to ferrule main body 221 in the state of being held by optical transmission member holding member 230, it is less broken when positioning the end surface of optical transmission member 110 with respect to first optical surface 123. In addition, optical transmission member holding member 130 that holds optical transmission member 110 with the ridge and valley is easily disposed at an appropriate position. In this manner, the position of the end surface of optical transmission member 110 is easily set with respect to first optical surface 123.

### Embodiment 3

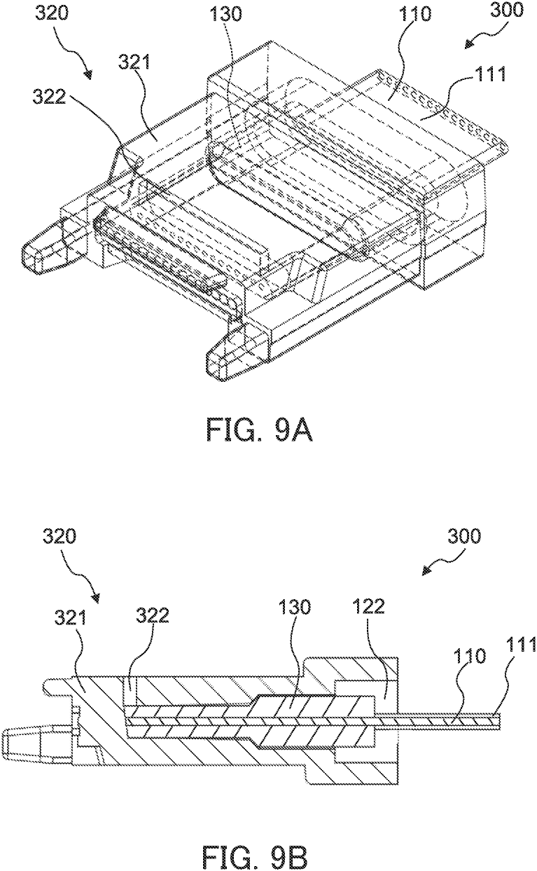

FIG. 9A is a see-through perspective view illustrating a configuration of optical connector 300 according to Embodiment 3 of the present invention, and FIG. 9B is a sectional view. In optical connector 300 and ferrule 320, the same components as those of optical connector 100 and ferrule 120 are denoted with the same reference numerals, and the description thereof is omitted.

Ferrule 320 includes adhesive introduction part 322 that communicates between the outside and the space between the end surface of optical transmission member 110 and first optical surface 123 in the state where optical transmission member holding member 130 is inserted to insertion part 122. In FIGS. 9A and 9B, adhesive introduction part 322 is a through hole provided at ferrule main body 321 and configured to communicate between the outside of ferrule main body 321 and insertion part 122. In the example illustrated in FIGS. 9A and 9B, by introducing optically transparent adhesive from adhesive introduction part 322 composed of a through hole, optical transmission member holding member 130 can be fixed to ferrule main body 321 while filling the space between the end surface of optical transmission member 110 and first optical surface 123 with the adhesive.

The through hole may open on the front side of ferrule main body 321, or may open on the rear side of ferrule main body 321. In the present embodiment, the through hole is open on the front side of ferrule main body 321.

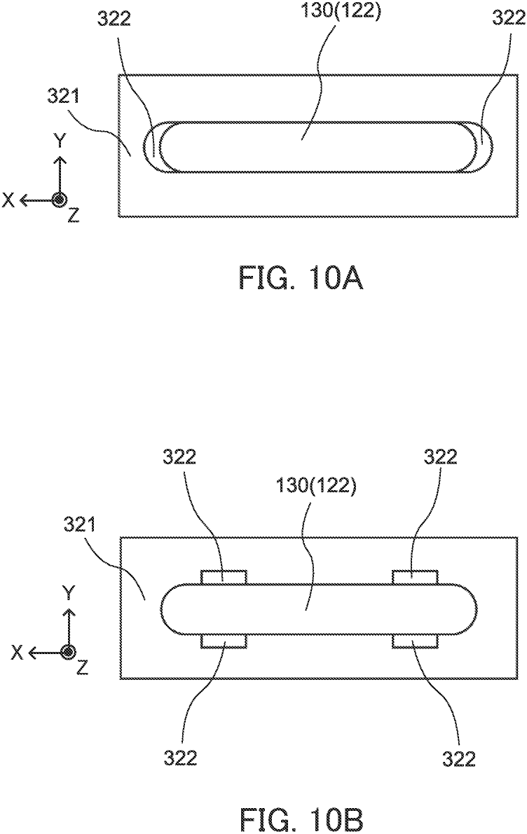

FIGS. 10A and 10B are diagrams illustrating another example of adhesive introduction part 322. FIGS. 10A and 10B are back views of ferrule main body 321 in the state where optical transmission member holding member 130 is inserted. As illustrated in FIGS. 10A and 10B, adhesive introduction part 322 may be a recess disposed at the inner surface of insertion part 122. With such a recess, a space is formed between the side surface of optical transmission member holding member 130 and the inner surface of insertion part 122. Such a space can introduce adhesive, and can function as adhesive introduction part 322.

Adhesive introduction part 322 illustrated in FIG. 10A is two valleys disposed at both end portions in the X direction in the inner surface of insertion part 122 of ferrule main body 321. These valleys extend in the insertion direction (the Z direction) of optical transmission member holding member.

Adhesive introduction part 322 illustrated in FIG. 10B is four valleys provided in the top surface and bottom surface in the inner surface of insertion part 122 of ferrule main body 321.

### Effects

With ferrule 320 according to Embodiment 3, optical transmission member holding member 130 can be easily fixed to ferrule main body 321 by using adhesive while achieving the effects of ferrule 120 according to Embodiment 1.

### Industrial Applicability

With the ferrule according to the present invention, the optical transmission member can be easily aligned while preventing the breaking of the optical transmission member, and therefore the ferrule according to the present invention is suitable for highly accurately performing optical communications using optical transmission members.

### Reference Signs List

100, 200, 300 Optical connector
110 Optical transmission member
111 Cover part
120, 220, 320 Ferrule
121, 221, 321 Ferrule main body
122, 222 Insertion part
123 First optical surface
124 Second optical surface
125 Positioning part
130, 230 Optical transmission member holding member
223 Valley
231 Ridge
322 Adhesive introduction part

1. A ferrule comprising:
an optical transmission member holding member configured to hold an optical transmission member; and
a ferrule main body to which the optical transmission member holding member is inserted,
wherein the ferrule main body includes:
an insertion part to which the optical transmission member holding member is inserted,
a first optical surface disposed to face an end surface of the optical transmission member held by the optical transmission member holding member, and
a positioning part configured to set a position of the optical transmission member holding member when the optical transmission member holding member is inserted to the insertion part.

2. The ferrule according to claim 1, wherein the optical transmission member holding member is press-fitted to the ferrule main body at the positioning part.

3. The ferrule according to claim 1,
wherein the insertion part is an inner surface of a recess; and
wherein the positioning part is a tapered surface disposed at two opposing inner surfaces in the insertion part, the tapered surface tapering from an opening of the insertion part toward the first optical surface.

4. The ferrule according to claim 1,
wherein the optical transmission member holding member includes a ridge or a valley extending in an insertion direction into the insertion part; and
wherein the positioning part is a valley or a ridge extending in a direction from an opening of the insertion part toward the first optical surface and having a shape corresponding to the ridge or the valley of the optical transmission member holding member.

5. The ferrule according to claim 1, wherein the first optical surface is a tilted surface tilted with respect to an insertion direction of the optical transmission member holding member into the insertion part.

6. The ferrule according to claim 1, further comprising an adhesive introduction part configured to communicate between outside and a space between the first optical surface and the end surface of the optical transmission member held by the optical transmission member holding member in a state where the optical transmission member holding member is inserted to the insertion part.

7. The ferrule according to claim 6, wherein the adhesive introduction part includes a recess disposed at an inner surface of the insertion part.

8. The ferrule according to claim 6, wherein the adhesive introduction part includes a through hole disposed at the ferrule main body.

9. An optical connector comprising:
the ferrule according to claim 1; and
an optical transmission member held by the optical transmission member holding member.

10. An optical connector module comprising the optical connector according to claim 9.
